(19) United States
(12) Patent Application Publication
(10) Pub. No.: US 2020/0064821 A1
(43) Pub. Date: Feb. 27, 2020

(54) INSPECTION ASSISTANCE DEVICE, INSPECTION ASSISTANCE METHOD, AND RECORDING MEDIUM

(71) Applicant: NEC CORPORATION, Tokyo (JP)

(72) Inventors: Takami SATO, Tokyo (JP); Kota IWAMOTO, Tokyo (JP); Yoshinori SAIDA, Tokyo (JP); Shin NORIEDA, Tokyo (JP)

(73) Assignee: NEC CORPORATION, Tokyo (JP)

(21) Appl. No.: 16/489,067

(22) PCT Filed: Feb. 28, 2017
(86) PCT No.: PCT/JP2017/007771

§ 371 Date: Aug. 27, 2019

(51) Int. Cl. G05B 23/02; G02B 27/01

(52) U.S. Cl. CPC G05B 23/0216; G05B 23/0283; G05B 23/0264; G02B 2027/0141; G02B 2027/0178; G02B 2027/0138; G02B 2027/014; G02B 27/017

(57) ABSTRACT

Provided is an inspection assistance device which includes: a data acquisition unit that acquires data generated as a result of an operation for inspection; a time acquisition unit that acquires, from the data, a first time required by the operation for the inspection; and a recording control unit that, in the case when a prescribed relation is satisfied by the first time and a second time which is previously determined as a time required by the operation for the inspection, records operation-related information recognized from the data and information related to the inspection in association with each other.

### TECHNICAL FIELD

The present disclosure relates to an inspection assistance device, an inspection assistance method, and a recording medium.

### BACKGROUND ART

Methods of assisting inspection work on equipment such as a measuring instrument are disclosed. For example, PTL 1 describes a work assistance device displaying an instruction to perform a pointing and calling action at a predetermined point in work, capturing an image of the action and recording a sound of the pointing and calling action performed by a worker in response to the instruction, and checking whether or not the pointing and calling action is correctly performed, by making comparisons about the captured image and the voice.

PTL 2 describes a system displaying an image acquired by superimposing status of a monitoring target close to the monitoring target on a monitoring image in which the monitoring target is captured, by use of an augmented reality technology.

PTL 3 describes a robot recognizing work details of work by a user, based on a captured image, and performing the work details.

### CITATION LIST

### Patent Literature

PTL 1: Japanese Unexamined Patent Application Publication No. 2015-219538

PTL 2: Japanese Unexamined Patent Application Publication No. 2012-18605

PTL 3: Japanese Unexamined Patent Application Publication No. 2015-44257

### SUMMARY OF INVENTION

### Technical Problem

Some work on an inspection target may acquire a correct inspection result by completing the work within a previously set work time. For example, in inspection work on an inspection target a state of which changes by a time span, the inspection target needs to be inspected within a period in which the state does not change. However, in the technology described in aforementioned PTL 1, a time required for an inspection on an inspection target is not mentioned at all. Accordingly, in a technology related to aforementioned PTL 1, even a case of inspection work not being completed within a previously set work time may be stored as a correct inspection result.

The present disclosure has been made in view of the aforementioned problem, and an object of the present disclosure is to provide a technology capable of efficiently recording data being valid as information about an action for an inspection, such as an inspection result on an inspection target.

### Solution to Problem

An inspection assistance device according to an aspect of the present disclosure includes a data acquisition means configured to acquire data generated by an action for an inspection, a time acquisition means configured to acquire a first time required for an action for the inspection, from the data, and a recording control means configured to, when the first time and a second time predetermined as a time required for an action for the inspection are in a predetermined relation, record information about an action recognized from the data and information about the inspection in association with each other.

Further, an inspection assistance method according to an aspect of the present disclosure includes acquiring data generated by an action for an inspection, acquiring a first time required for an action for the inspection, from the data, and, when the first time and a second time predetermined as a time required for an action for the inspection are in a predetermined relation, recording information about an action recognized from the data and information about the inspection in association with each other.

A computer program providing the aforementioned device or method by a computer, and a computer-readable non-transitory recording medium storing the computer program also fall under the category of the present disclosure.

### Advantageous Effects of Invention

The present disclosure is able to efficiently record data being valid as information about an action for an inspection, such as an inspection result on an inspection target.

### BRIEF DESCRIPTION OF DRAWINGS

FIG. 1 is a functional block diagram illustrating an example of a functional configuration of an inspection assistance device according to a first example embodiment.

FIG. 2 is a diagram illustrating an application example of the inspection assistance device illustrated in FIG. 1.

FIG. 3 is a flowchart illustrating an example of a processing flow in the inspection assistance device according to the first example embodiment.

FIG. 4 is a diagram illustrating a configuration example of an inspection assistance system including an inspection assistance device according to a second example embodiment.

FIG. 5 is a diagram illustrating an application example of the inspection assistance system illustrated in FIG. 4.

FIG. 6 is a diagram illustrating an example of inspection information.

FIG. 7 is a flowchart illustrating an example of a processing flow in the inspection assistance device according to the second example embodiment.

FIG. 8 is a diagram illustrating an example of a display screen displayed by a display unit.

FIG. 9 is a diagram illustrating an example of recorded information recorded in a recording unit.

FIG. 10 is a diagram illustrating a configuration example of an inspection assistance system including an inspection assistance device according to a third example embodiment.

FIG. 11 is a diagram illustrating an example of recorded information recorded in a recording unit.

FIG. 12 is a diagram exemplarily illustrating a hardware configuration of a computer (information processing device) capable of providing each example embodiment.

### EXAMPLE EMBODIMENT

### First Example Embodiment

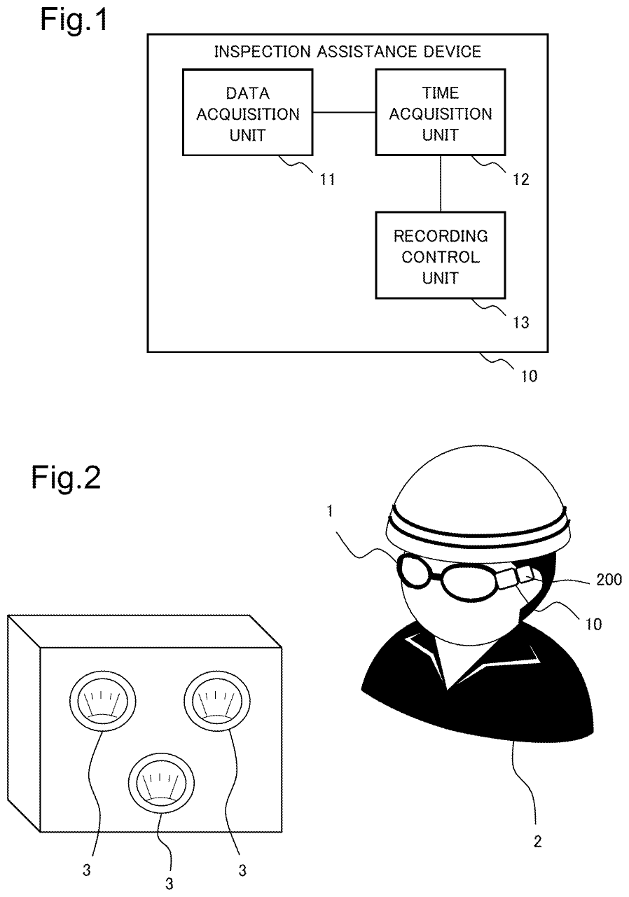

A first example embodiment of the present disclosure will be described with reference to drawings. FIG. 1 is a functional block diagram illustrating an example of a functional configuration of an inspection assistance device 10 according to the present example embodiment. FIG. 2 is a diagram illustrating an application example of the inspection assistance device 10 illustrated in FIG. 1. As illustrated in FIG. 1, the inspection assistance device 10 according to the present example embodiment includes a data acquisition unit 11, a time acquisition unit 12, and a recording control unit 13.

The data acquisition unit 11 acquires data generated by an action for an inspection. For example, the data acquisition unit 11 acquires image data captured by an imaging device or acoustic data collected by a sound collecting device, as data generated by an action for an inspection. For example, an action for an inspection may be an action for acquiring an inspection result on an inspection target, may be a predetermined calling action performed at the inspection, a movement for performing the inspection, or another action.

The time acquisition unit 12 acquires a first time required for an action for an inspection from data acquired by the data acquisition unit 11. For example, when the data acquisition unit 11 acquires image data, the time acquisition unit 12 acquires a first time required for an action for an inspection from the image data. Further, for example, when the data acquisition unit 11 acquires acoustic data, the time acquisition unit 12 acquires a first time from the acoustic data. For example, the time acquisition unit 12 may acquire, as a first time, a period from a time when a predetermined target (such as an inspection target or a tool used for inspection) is included in image data to a time when the predetermined target is no longer included. Further, the time acquisition unit 12 may acquire a first time, based on whether or not a predetermined action is included in image data. For example, the time acquisition unit 12 may acquire, as a first time, a period from a time when an action indicating a start of inspection is included in image data to a time when an action indicating an end of inspection is included in the image data. Further, the time acquisition unit 12 may acquire a first time, based on whether or not a predetermined sound is included in acoustic data. For example, the time acquisition unit 12 may acquire, as a first time, a period from a time when a sound indicating a start of inspection is included in acoustic data to a time when a sound indicating an end of inspection is included. A method of acquiring a first time by the time acquisition unit 12, based on acquired data, is not particularly limited.

When a first time and a second time predetermined as a time required for an action for an inspection are in a predetermined relation, the recording control unit 13 records information about an action recognized from data acquired by the data acquisition unit 11 and information about the inspection in association with each other. For example, information about an action recognized from data is information about an inspection result acquired by the action recognized from the data. Further, for example, information about an inspection is information about an inspection target. For example, when a difference between a first time and a second time is less than or equal to a predetermined threshold value, the recording control unit 13 records information about an action recognized from data and information about the inspection in association with each other. For example, the recording control unit 13 records the associated information into a recording medium such as a hard disk drive or paper.

Next, an application example of the inspection assistance device 10 will be described with reference to FIG. 2. For example, the inspection assistance device 10 is equipped on a glasses type wearable terminal, as illustrated in FIG. 2. The glasses type wearable terminal is hereinafter referred to as wearable glasses 1. Further, a data acquisition device 200 is a device generating data acquired by the data acquisition unit 11 and is, for example, an imaging device or a sound collecting device. When the data acquisition device 200 is an imaging device, the data acquisition device 200 equipped on the wearable glasses 1 captures an image of an inspection target 3 such as a measuring instrument by, for example, a worker 2 wearing the wearable glasses 1 turning his/her face in a direction of the inspection target 3. The inspection assistance device 10 according to the present example embodiment may be provided by a device communicable with the wearable glasses 1.

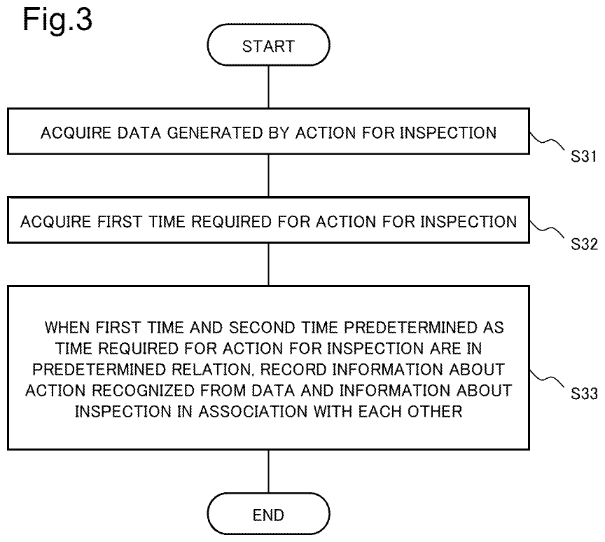

FIG. 3 is a flowchart illustrating an example of a processing flow in the inspection assistance device 10 according to the present example embodiment. As described in FIG. 3, the data acquisition unit 11 acquires data generated by an action for an inspection (Step S31). Further, the time acquisition unit 12 acquires a first time required for the action for the inspection from the data acquired in Step S31 (Step S32). Then, when the first time and a second time predetermined as a time required for the action for the inspection are in a predetermined relation, the recording control unit 13 records information about an action recognized from the data and information about the inspection in association with each other (Step S33).

Thus, for example, when a first time required for an action for an inspection by the worker 2 does not have a predetermined relation with a predetermined second time, the inspection assistance device 10 according to the present example embodiment does not record information about an action recognized from data. For example, when a first time required for an action for acquiring an inspection result on an inspection target is longer than a second time by a predetermined time or greater, there is a possibility that work different from set inspection work is performed. Further, for example, when a first time required for an action for acquiring an inspection result on an inspection target is shorter than a second time by a predetermined time or greater, there is a possibility that set inspection work is not performed. Accordingly, in such a case, the inspection assistance device 10 does not record information about the action requiring the first time.

Thus, the inspection assistance device 10 according to the present example embodiment can efficiently record data valid as information about an action for an inspection recognized from data. Consequently, for example, even when inspection work is not performed due to a poor attitude of a worker, or the like, recording of data not undergoing inspection work can be prevented. Consequently, recording of unnecessary data can be restricted, and therefore recording efficiency can be improved. Further, by controlling recording by comparing a first time required for an action for an inspection with a predetermined second time, as is the case with the inspection assistance device 10 according to the present example embodiment, processing efficiency can be improved compared with a case of analyzing an action included in data and comparing actions.

Further, for example, a supervisor checking inspection work by use of recorded data can check data valid as information about an action for the inspection, such as an inspection result on an inspection target. Accordingly, the inspection assistance device 10 can more efficiently assist work related to inspection.

### Second Example Embodiment

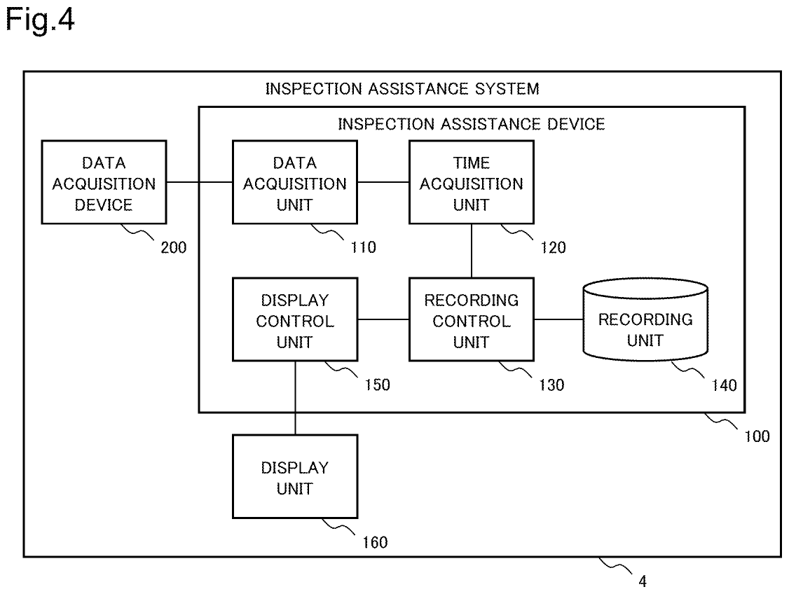

Next, a second example embodiment of the present disclosure based on the aforementioned first example embodiment will be described with reference to drawings. FIG. 4 is a diagram illustrating a configuration example of an inspection assistance system 4 including an inspection assistance device 100 according to the present example embodiment. As illustrated in FIG. 4, the inspection assistance system 4 includes the inspection assistance device 100, a data acquisition device 200, and a display unit 160.

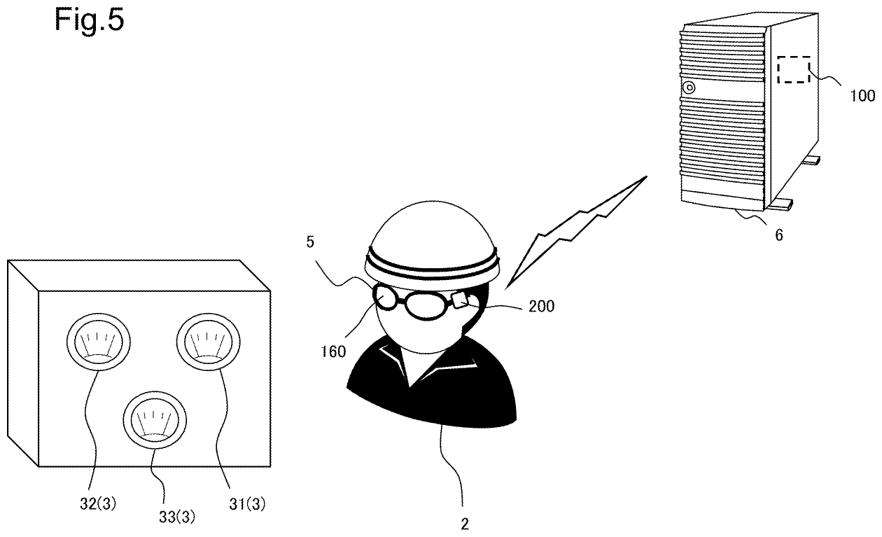

FIG. 5 is a diagram illustrating an application example of the inspection assistance system 4 illustrated in FIG. 4. As illustrated in FIG. 5, the data acquisition device 200 is equipped on wearable glasses 5, and the inspection assistance device 100 may be equipped on a server device 6 communicable with the wearable glasses 5. In a case of the data acquisition device 200 being an imaging device such as a camera, when a worker 2 wearing the wearable glasses 5 starts an inspection, the data acquisition device 200 captures an image. For example, by the worker 2 turning his/her face toward an inspection target 3 such as a measuring instrument, the data acquisition device 200 captures an image of the inspection target 3. The captured image may be displayed on the display unit 160 being a lens part of the wearable glasses 5.

Further, for example, in a case of the data acquisition device 200 being a sound collecting device such as a microphone, when the worker 2 wearing the wearable glasses 5 starts an inspection, the data acquisition device 200 collects sound around the worker 2. For example, when an inspection item indicates collection of sound when going through a certain route, the worker 2 goes through the route as an action for the inspection. At this time, the data acquisition device 200 collects sound. Consequently, the data acquisition device 200 generates acoustic data representing the collected sound.

For example, an inspection target 3 is a sensor, such as a thermometer, a switch, a structure, or the like being a target of inspection. Further, when an inspection item indicates going through a predetermined route or the like, a structure related to the route may be set as an inspection target 3 or a state around the route may be set as an inspection target 3. An inspection target 3 is not particularly limited as long as the inspection target 3 serves as an inspection target.

The inspection assistance device 100 may be equipped on the wearable glasses 5, or part of functions of the inspection assistance device 100 (for example, a display control unit 150 illustrated in FIG. 4) may be equipped on the wearable glasses 5.

The data acquisition device 200 generates data including information related to an action for an inspection. For example, the data acquisition device 200 is an imaging device such as a camera. Further, for example, the data acquisition device 200 is a sound collecting device such as a microphone. The present example embodiment will be described on an assumption that the data acquisition device 200 is an imaging device.

The data acquisition device 200 generates image data representing a captured image by the worker 2 performing an action for an inspection. The generated image data may be stored in the data acquisition device 200 or may be stored in a storage device different from the data acquisition device 200. An image captured by the data acquisition device 200 may be a dynamic image or a static image. Further, image data may include time information indicating a time when the image is captured and positional information indicating a position where the image is captured. Upon generating image data, the data acquisition device 200 may provide the image data for the inspection assistance device 100.

As illustrated in FIG. 4, the inspection assistance device 100 includes a data acquisition unit 110, a time acquisition unit 120, a recording control unit 130, a recording unit 140, and a display control unit 150. The recording unit 140 may be provided by a storage device different from the inspection assistance device 100.

The data acquisition unit 110 is an example of the data acquisition unit 11 according to the first example embodiment. The data acquisition unit 110 acquires data acquired by the data acquisition device 200. The data acquisition unit 110 according to the present example embodiment acquires image data captured by the data acquisition device 200. The data acquisition unit 110 may acquire image data from the data acquisition device 200 or from a storage device. Further, the data acquisition unit 110 may acquire entire image data captured by the data acquisition device 200 or may acquire part of the image data. By the data acquisition unit 110 acquiring part of the image data captured by the data acquisition device 200, an amount of data can be reduced compared with a case of acquiring the entire image data. The data acquisition unit 110 provides the acquired image data for the time acquisition unit 120.

The time acquisition unit 120 is an example of the time acquisition unit 12 according to the first example embodiment. The time acquisition unit 120 acquires a first time required for an action for an inspection from data acquired by the data acquisition unit 110. The time acquisition unit 120 according to the present example embodiment acquires a first time required for an action for an inspection from image data acquired by the data acquisition unit 110. A specific example of an acquisition method of a first time will be described later. The time acquisition unit 120 provides the acquired first time for the recording control unit 130 along with image data from which the first time is acquired.

The recording control unit 130 is an example of the recording control unit 13 according to the first example embodiment. When a first time and a second time predetermined as a time required for an action for an inspection are in a predetermined relation, the recording control unit 130 records information about an action recognized from data acquired by the data acquisition unit 110 and information about the inspection (referred to as inspection information) in association with each other.

Specifically, the recording control unit 130 receives a first time from the time acquisition unit 120 along with image data. The recording control unit 130 acquires a second time predetermined as a time required for an action for the inspection from, for example, the recording unit 140 to be described later. Then, the recording control unit 130 determines whether or not the first time and the second time are in a predetermined relation. For example, the recording control unit 130 determines whether or not a difference between the first time and the second time is within a predetermined range. Further, for example, the recording control unit 130 determines whether or not the first time exceeds the second time. When the first time and the second time are in the predetermined relation, the recording control unit 130 recognizes an action for the inspection from the image data. Then, the recording control unit 130 stores information about the recognized action and inspection information about the inspection in association with each other into, for example, the recording unit 140. The information about the action recognized by the recording control unit 130 may be the action itself or an inspection result acquired by the action. Further, a method of recognizing an action by the recording control unit 130 is not particularly limited, and an arbitrary method may be used. Further, the inspection information about the inspection may be information about an inspection target 3 being a target of the inspection. Information about an inspection target 3 includes an inspection target name indicating the inspection target 3 and an inspection item but is not limited to the above. Further, the recording control unit 130 may be configured to accept a recognition result from a device performing the aforementioned recognition, or the like.

While the recording control unit 130 according to the present example embodiment stores associated information into the recording unit 140, the recording control unit 130 may be configured to record the associated information in paper or another medium, and output the information to the display unit 160. The information (referred to as recorded information) stored into the recording unit 140 by the recording control unit 130 will be described later in a separate drawing.

When the first time and the second time are in the predetermined relation, the recording control unit 130 may further determine whether or not an action (referred to as a first action) recognized from the data acquired by the data acquisition unit 110 and an action (referred to as a second action) predetermined as an action for the inspection are in a predetermined relation. For example, when a type of the first action is identical to a type of the second action, the recording control unit 130 determines that the first action and the second action are in a predetermined relation. Further, for example, when specific details of the first action are identical to details of the second action, the recording control unit 130 determines that the first action and the second action are in a predetermined relation. Being in a predetermined relation is not limited to a match and has only to satisfy a degree of similarity being greater than or equal to a predetermined threshold value. Then, when the first action and the second action are in the predetermined relation, the recording control unit 130 may record information about the first action recognized from the acquired data and information about the inspection in association with each other.

When a first time and a second time are in a predetermined relation, and a first action and a second action are in a predetermined relation, an action recognized from acquired data is highly likely to be a correct action as an action for performing the inspection. Accordingly, the recording control unit 130 may record information about the first action, such as an inspection result acquired from the correct action, and information about the inspection in association with each other. Thus, information about a first action recording the recording control unit 130 is highly likely to be valid data with regard to inspection work. Accordingly, the inspection assistance device 100 can record data more accurate as valid data. Accordingly, even when image data, information about an inspection result, or the like is falsified due to a poor attitude of the worker 2, or the like, or when the worker 2 does not perform inspection work by a set action, the inspection assistance device 100 can prevent recording of falsified or mistaken data.

For example, the recording unit 140 is provided by a hard disk drive. The recording unit 140 stores information in a hard disk about an action and inspection information that are associated with each other by the recording control unit 130.

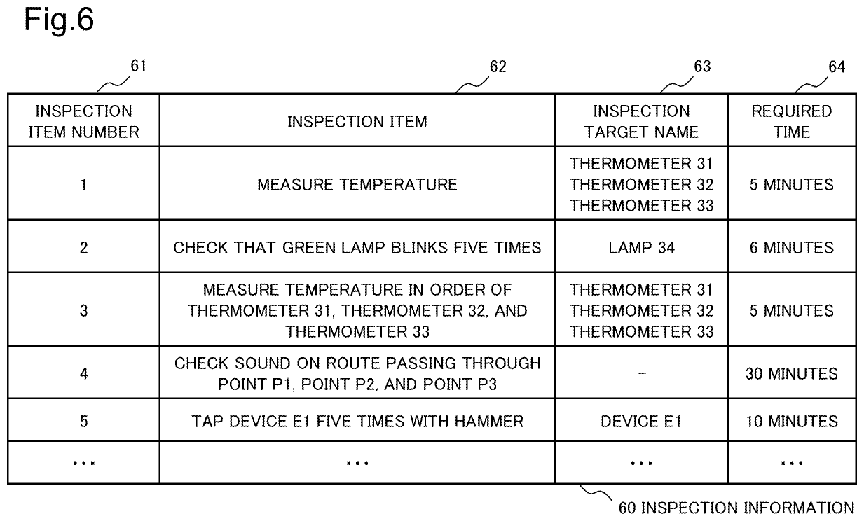

Further, the recording unit 140 may store inspection information being information about an inspection. Inspection information may be stored in a storage device separate from the recording unit 140. An example of inspection information is illustrated in FIG. 6. FIG. 6 is a diagram illustrating an example of inspection information 60. As illustrated in FIG. 6, each record of the inspection information 60 includes an inspection item number 61 for identifying an inspection item, an inspection item 62 indicating details of inspection work, an inspection target name 63 indicating an inspection target 3, and a required time (second time) 64 predetermined as a time required for an action for the inspection. The inspection information 60 may include a scheduled time at which an inspection of the inspection target 3 starts or may include other information. For example, the inspection information 60 may include information indicating a position of an inspection target. Further, for example, when an action for an inspection is to go through a predetermined route, a record related to the inspection item may not include an inspection target name 63. Further, the inspection item 62 in the inspection information 60 illustrated in FIG. 6 indicates a second action; however, when the inspection item 62 does not indicate a second action, information indicating a second action may be included in the inspection information 60.

By referring to the inspection information 60, the recording control unit 130 acquires a second time being the required time 64. For example, triggered by an input device (for example, an input device 300 according to a third example embodiment, to be described later) capable of text input accepting an inspection item number, the recording control unit 130 may identify an inspection item number 61 being a number identical to the accepted inspection item number and acquire a required time 64 related to the identified inspection item number 61 as a second time. Further, the recording control unit 130 may identify an inspection target 3 or an inspection item from data acquired by the data acquisition unit 110 and acquire a required time 64 related to the identified inspection target or inspection item as a second time.

The display control unit 150 causes the display unit 160 to display recording result information based on a result of recording by the recording control unit 130. Further, the display control unit 150 may cause the display unit 160 to display data acquired by the data acquisition unit 110 and information about the data.

For example, as illustrated in FIG. 5, the display unit 160 is a lens part of the wearable glasses 5 and is provided by, for example, a display module transmitting external light and displaying information in accordance with an instruction from the display control unit 150. The display unit 160 is not limited to the above. The display unit 160 may be a module having a function of displaying information generated by the display control unit 150 on a retina of the worker 2. Thus, the display unit 160 may have a function of projecting information generated by the display control unit 150, in accordance with control by the display control unit 150. The function of projecting information generated by the display control unit 150 may be included in the display control unit 150. For example, assuming that the display unit 160 is a retina, the display control unit 150 may have a function of directly projecting generated information on the retina.

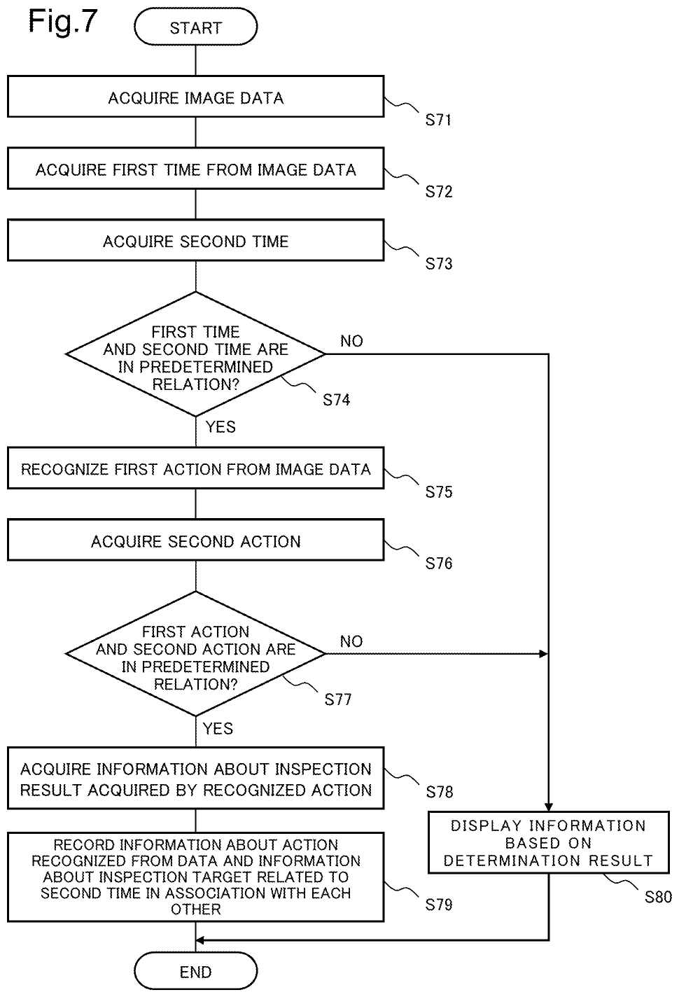

FIG. 7 is a flowchart illustrating an example of a processing flow in the inspection assistance device 100 according to the present example embodiment. As described above, it is assumed that data acquired by the data acquisition unit 110 are image data, according to the present example embodiment. Further, the flowchart illustrated in FIG. 7 will be described on an assumption that an action for an inspection performed by the worker 2 is an action for acquiring an inspection result on an inspection target 3.

As described in FIG. 7, the data acquisition unit 110 acquires image data generated by an action for an inspection (Step S71). Then, the time acquisition unit 120 acquires a first time required for the action for the inspection from the image data (Step S72).

Then, the recording control unit 130 acquires a second time predetermined as a time required for the action for the inspection (Step S73). Then, the recording control unit 130 determines whether or not the first time and the second time are in a predetermined relation (Step S74).

When the first time and the second time are in the predetermined relation (YES in Step S74), the recording control unit 130 recognizes a first action from the image data acquired in Step S71 (Step S75). Further, the recording control unit 130 acquires a second action being predetermined as an action for the inspection and being associated with the second time (Step S76). Step S75 and Step S76 may be performed simultaneously or may be performed in reverse order.

Then, the recording control unit 130 determines whether or not the first action and the second action are in a predetermined relation (Step S77). When the first action and the second action are in the predetermined relation (YES in Step S77), the recording control unit 130 acquires information about an inspection result acquired from the recognized action (Step S78).

Then, the recording control unit 130 records the information about the inspection result and information about the inspection, such as information about an inspection target related to the second time, in association with each other (Step S79) and ends the processing.

Further, when the first time and the second time are not in the predetermined relation (NO in Step S74), or when the first action and the second action are not in the predetermined relation (NO in Step S77), the display control unit 150 causes the display unit 160 to display information based on the determination result (Step S80) and ends the processing. When the determination results in Step S74 and Step S77 are NO, the associated information is not recorded in the recording unit 140. Accordingly, Step S80 may be reworded as processing of causing the display unit 160 to display information based on a result of recording by the recording control unit 130.

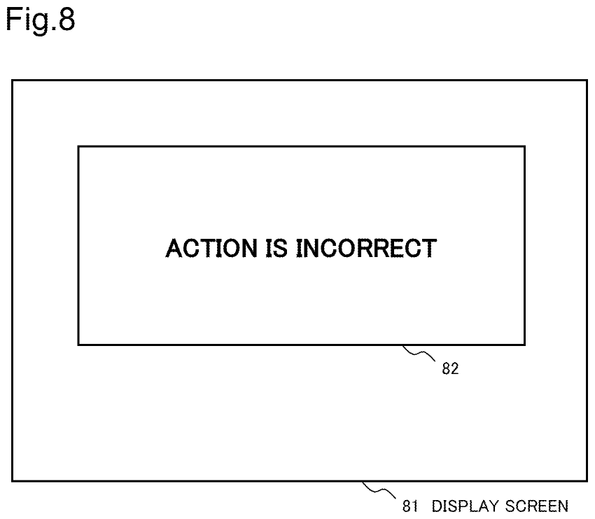

A display screen which the display control unit 150 causes the display unit 160 to display in Step S80 will be described with reference to FIG. 8. FIG. 8 is a diagram illustrating an example of a display screen displayed by the display unit 160.

For example, when the determination in Step S77 is NO, the display control unit 150 may cause the display unit 160 to display a display screen 81 including information 82 indicating to the worker 2 that the action related to the inspection is not a predetermined action, as illustrated in FIG. 8. Further, when the determination in Step S74 is NO, the display control unit 150 may cause the display unit 160 to display a display screen different from FIG. 8 or may cause the display unit 160 to display the same display screen. Further, after Step S79 ends, the display control unit 150 may cause the display unit 160 to display that the associated information is recorded in the recording unit 140.

Consequently, the worker 2 can readily grasp whether or not work performed by the worker 2 is correct.

Next, an acquisition method of a first time by the time acquisition unit 120 will be described. The time acquisition unit 120 may acquire a first time, based on whether or not a target related to an action for an inspection is included in image data. For example, when an action for an inspection is an action of measuring temperature as indicated in a record with an inspection item number 61 “1” in FIG. 6, the time acquisition unit 120 acquires a period from a time when a thermometer is included in the image data to a time when the thermometer is no longer included, as a first time. Specifically, when the image data include a plurality of frames, the time acquisition unit 120 acquires time information indicating an image capture time of a frame in which the thermometer is recognized from the image data. Further, the time acquisition unit 120 acquires time information indicating an image capture time of a frame immediately preceding a frame in which the thermometer is no longer included. Then, the time acquisition unit 120 calculates a first time from the two pieces of acquired time information. By employing such an acquisition method of a first time, the time acquisition unit 120 can highly accurately acquire a time required for an action for an inspection.

The time acquisition unit 120 may acquire a first time from image data, based on whether or not equipment or a structure previously registered as an inspection target 3 is included in the image data. Further, when an inspection item number is input by use of an unillustrated input device or the like, the time acquisition unit 120 may check whether or not an inspection target 3 related to the inspection item number 61 is included or may check whether or not a target of the same type as an inspection target 3 related to the inspection item number 61 is included.

For example, when an action for an inspection is checking sound on a route passing through a point P1, a point P2, and a point P3, as indicated in a record with an inspection item number 61 “4” in FIG. 6, the worker 2 goes through the point P1, the point P2, and the point P3 for inspection. In this case, the time acquisition unit 120 may set a period from a time when equipment or a structure around the point P1 is included in image data to a time when equipment or a structure around the point P3 is included in the image data, as a first time.

Further, a target related to an action for an inspection is not limited to an inspection target 3 and may be a tool used for inspection work. For example, when an inspection is performed by use of a tool such as a hammer, as indicated in an inspection item 62 in a record with an inspection item number 61 “5” in FIG. 6, the time acquisition unit 120 may acquire a first time, based on whether or not the tool is included in image data.

Further, the time acquisition unit 120 may acquire a first time, based on whether or not a predetermined action is included in image data. For example, the time acquisition unit 120 may acquire a period from a time when an action by a finger of the worker 2, the action indicating a start of work, is included to a time when an action by a finger of the worker 2, the action indicating an end of the work, is included, as a first time. Further, a predetermined action may be an action of inspection work itself. For example, when an inspection is performed by use of a tool such as a hammer, as indicated in the inspection item 62 in the record with the inspection item number 61 “5” in FIG. 6, the time acquisition unit 120 may acquire a period from the first time a device E1 is tapped to the last time the device E1 is tapped, as a first time. A determination method of the last time the device E1 is tapped is not particularly limited. For example, a time when the hammer is no longer included in image data may be set as the last time the device E1 is tapped, or when tapping is not detected for a predetermined time after the device E1 is tapped, the time when the device E1 is tapped may be set as the last time the device E1 is tapped. By employing such an acquisition method of a first time, the time acquisition unit 120 can highly accurately acquire a time required for an action for an inspection.

Further, the time acquisition unit 120 may acquire a first time, based on an amount of movement of a line of sight of the worker 2, the amount being calculated from image data. For example, when an action for an inspection is an action of measuring temperature, as indicated in the record with the inspection item number 61 “1” in FIG. 6, the worker 2 needs to visually identify a thermometer. In such a case, an amount of movement of a line of sight of the worker 2 in a predetermined time becomes less than a predetermined threshold value. Accordingly, when the amount of movement of the line of sight of the worker 2 is less than the predetermined threshold value, the time acquisition unit 120 determines that the action for the inspection starts. Then, when the amount of movement of the line of sight of the worker 2 becomes greater than the predetermined threshold value, the time acquisition unit 120 determines that the action for the inspection ends. Then, the time acquisition unit 120 acquires a period from a time when the action for the inspection starts to a time when the action for the inspection ends, as a first time. By employing such an acquisition method of a first time, for example, when an inspection performed by the worker 2 is such an action as to visually identify an inspection target 3, the time acquisition unit 120 can highly accurately acquire a time required for the action for the inspection.

Further, when an inspection item number is input by use of an unillustrated input device or the like, and information about a place where inspection work is performed is included in the inspection information 60, the time acquisition unit 120 may acquire a first time, based on whether or not positional information included in image data and the information about the place where the inspection work is performed are in a predetermined relation. For example, when an action for an inspection is checking sound on a route passing through the point P1, the point P2, and the point P3, as indicated in the record with the inspection item number 61 “4” in FIG. 6, the worker 2 goes through the point P1, the point P2, and the point P3 for inspection. In this case, the time acquisition unit 120 may set a period from a frame including positional information corresponding to the point P1 in image data to a frame including positional information corresponding to the point P3, as a first time.

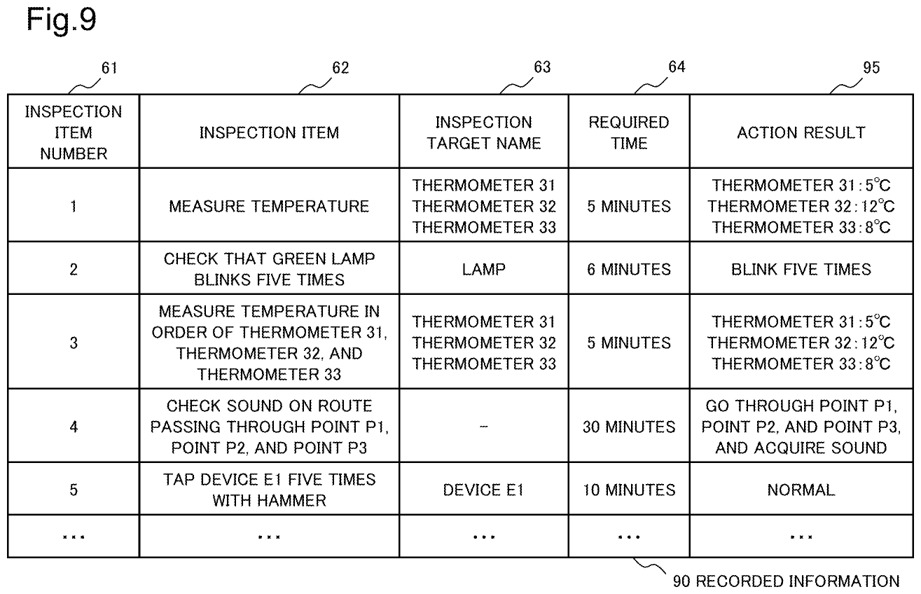

An example of recorded information recorded in the recording unit 140 will be described by use of FIG. 9. FIG. 9 is a diagram illustrating an example of recorded information 90 recorded in the recording unit 140. As illustrated in FIG. 9, the recorded information 90 includes an inspection item number 61, an inspection item 62, an inspection target name 63, and a required time 64 that constitute inspection information 60, and an action result 95 associated with the inspection information 60. The recorded information 90 is not limited to the above and may include other information.

An action result 95 is information about an action recognized by the recording control unit 130 from data acquired by the data acquisition unit 110. An action result 95 may be an inspection result itself on an inspection target 3 or may be data by which an inspection result can be acquired.

For example, when inspection targets 3 are a thermometer 31, a thermometer 32, and a thermometer 33 as indicated in a record with an inspection item number 61 “1” in FIG. 9, the recording control unit 130 recognizes temperature of each of the thermometer 31, the thermometer 32, and the thermometer 33 from image data by an action of measuring temperature of a thermometer and set the temperature as an action result 95. Then, the recording control unit 130 records the recognized temperature in association with the related record. A method of recognizing temperature from image data is not particularly limited, and an arbitrary method may be used.

Further, for example, when an inspection item 62 indicates checking that a green lamp blinks five times, as indicated in a record with an inspection item number 61 “2” in FIG. 9, the recording control unit 130 may recognize a blink count of the green lamp and set the recognized blink count as an action result 95. At this time, when the inspection item 62 includes a time length of a blink count check, a lighting time length of the lamp, and a blinking time length of the lamp, the recording control unit 130 may recognize a blink count of the lamp satisfying the conditions. Further, for example, when the inspection item 62 includes a blinking pattern of the lamp, the recording control unit 130 may recognize a blinking count in the pattern. Then, the recording control unit 130 records the recognized blink count in association with the related record.

Further, for example, when an inspection item 62 indicates tapping a device E1 five times with a hammer, as indicated in a record with an inspection item number 61 “5” in FIG. 9, the recording control unit 130 may set tapping five times as an action result 95. Further, the recording control unit 130 may recognize whether or not there is an abnormality as a result of tapping five times from acquired data and set the recognized result (“NORMAL” in the case of FIG. 9) as an action result 95. Then, the recording control unit 130 records the recognized result in association with the related record.

Further, an action result 95 may be a performed action itself, as is the case with a record with an inspection item number 61 “4” in FIG. 9. Further, an action result 95 may be a part or the whole of data by which an inspection result can be acquired, the data being acquired by the data acquisition unit 110.

The inspection information 60 included in the recorded information 90 has only to be information by which an inspection item can be identified and for example, may be an inspection item number 61 alone.

As described above, the inspection assistance device 100 according to the present example embodiment can efficiently record data valid as information about an action for an inspection recognized from data, similarly to the inspection assistance device 10 according to the aforementioned first example embodiment. Consequently, for example, even when inspection work is not performed due to a poor attitude of a worker, or the like, recording of data not undergoing inspection work can be prevented. Consequently, recording of unnecessary data can be restricted, and therefore recording efficiency can be improved.

Further, for example, a supervisor checking inspection work by use of recorded data can check data valid as information about an action for an inspection, such as an inspection result on an inspection target. Accordingly, the inspection assistance device 100 can more efficiently assist work related to inspection.

A case of data acquired by the data acquisition unit 110 being image data has been described as an example, according to the present example embodiment; however, data acquired by the data acquisition unit 110 may be acoustic data collected by a sound collecting device.

In this case, the time acquisition unit 120 acquires a first time from the acoustic data. Specifically, the time acquisition unit 120 acquires a first time, based on whether or not a predetermined sound is included in the acoustic data. For example, the time acquisition unit 120 may acquire a period from a time when a voice by an utterance of the worker 2 indicating a start of work is included to a time when a voice by an utterance of the worker 2 indicating an end of work is included, as a first time. Further, for example, when an inspection is performed by use of a tool such as a hammer, as indicated in the inspection item 62 in the record with the inspection item number 61 “5” in FIG. 6, the time acquisition unit 120 may acquire a period from the first time a sound generated upon tapping the device E1 is included in the acoustic data to the last time a sound generated upon tapping the device E1 is included in the acoustic data, as a first time.

By using such an acquisition method of a first time, the time acquisition unit 120 can highly accurately acquire a time required for an action for an inspection.

Further, when an order in which a plurality of actions included in a first action are performed matches an order in which a plurality of actions included in a second action are performed, the recording control unit 130 may record information about an action recognized from the data and information about the inspection in association with each other.

For example, when an order is set to actions for an inspection as indicated in an inspection item 62 in a record with an inspection item number 61 “3” in FIG. 6, the recording control unit 130 compares an order of thermometers measuring temperature, the order being recognized from data acquired by the data acquisition unit 110, with the order included in the inspection item 62. Then, when the order of thermometers measuring temperature is an order of the thermometer 31, the thermometer 32, and the thermometer 33, the recording control unit 130 records temperature acquired by the action recognized from the data as an action result 95 in association with the record with the inspection item number 61 “3,” as illustrated in FIG. 9.

Thus, by the recording control unit 130 further comparing an order of actions, accuracy of an action result 95 acquired by inspection work can be further improved.

### Third Example Embodiment

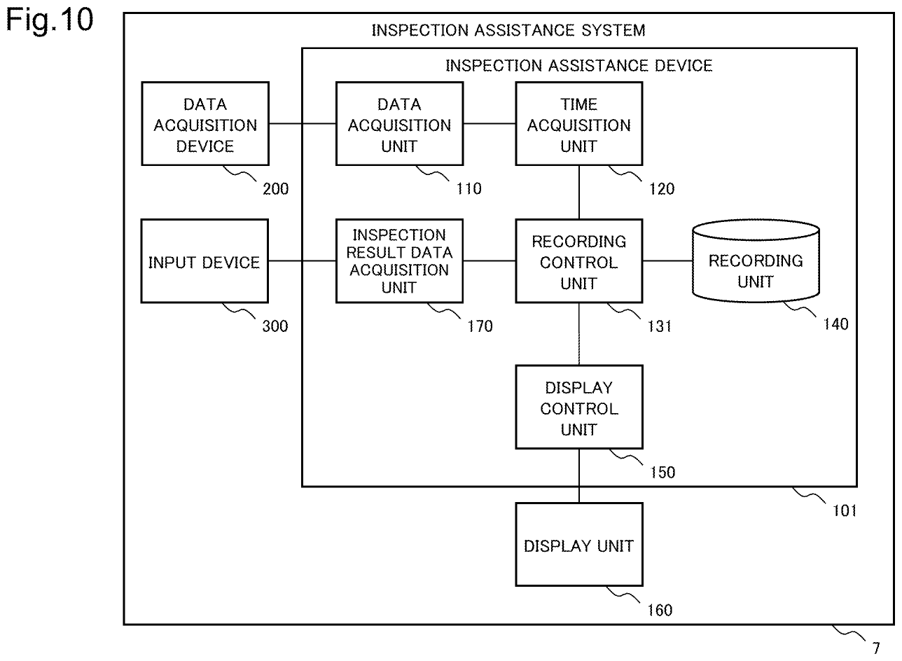

Next, a third example embodiment of the present disclosure will be described. FIG. 10 is a diagram illustrating a configuration example of an inspection assistance system 7 including an inspection assistance device 101 according to the present example embodiment. As illustrated in FIG. 10, the inspection assistance system 7 includes the inspection assistance device 101, a data acquisition device 200, a display unit 160, and an input device 300. The inspection assistance system 7 is configured to include the inspection assistance device 101 in place of the inspection assistance device 100 in the inspection assistance system 4 and further include the input device 300. A component having the same function as that of a component included in each of the aforementioned example embodiments is given the same sign, and detailed description thereof is omitted.

For example, the input device 300 is a device for a worker 2 to input an instruction. For example, the input device 300 may be a microphone being equipped on wearable glasses 5 and being capable of collecting voice of the worker 2, or the like. Further, the input device 300 may be a device separate from the wearable glasses 5, such as a keyboard. Further, the input device 300 may be a mobile terminal being separate from the wearable glasses 5 and including a touch panel, or the like. Input data representing information input to the input device 300 may be stored in the input device 300 or may be stored in a storage device different from the input device 300. Further, when accepting voice input or text input, the input device 300 may provide data (second data) representing the accepted information for the inspection assistance device 101.

As illustrated in FIG. 10, the inspection assistance device 101 includes a data acquisition unit 110, a time acquisition unit 120, a recording control unit 131, a recording unit 140, a display control unit 150, and an inspection result data acquisition unit 170. The inspection assistance device 101 is configured to include the recording control unit 131 in place of the recording control unit 130 in the inspection assistance device 100 and further include the inspection result data acquisition unit 170.

The inspection result data acquisition unit 170 acquires second data being information input by the worker 2 through the input device 300. Second data are used for acquiring an inspection result on an inspection target and are a different type of data from first data generated by an action for the inspection. Second data may be input data representing voice or text input by the worker 2 through the input device 300. Further, when the input device 300 is a software keyboard which the display control unit 150 causes the display unit 160 to display, the inspection result data acquisition unit 170 may acquire information indicating a position of a finger of the worker 2, as second data. The inspection result data acquisition unit 170 provides second data for the recording control unit 131.

The recording control unit 131 acquires information about an inspection result on an inspection target 3, based on first data being data being generated by an action for the inspection and being acquired by the data acquisition unit 110, similarly to the aforementioned recording control unit 130. For example, an inspection target 3 is a sensor such as a thermometer, a switch, a structure, or the like being a target of inspection, similarly to the second example embodiment. Further, when an inspection item indicates going through a predetermined route, or the like, a structure related to the route may be set as an inspection target 3, or a state around the route may be set as an inspection target 3. Further, the recording control unit 131 acquires information about an inspection result on an inspection target 3, based on second data received from the inspection result data acquisition unit 170.

The recording control unit 131 compares a comparison result between information about an inspection result acquired by an action recognized from first data and information about an inspection result based on acquired second data. Then, the recording control unit 131 records the comparison result and information about the inspection in association with each other.

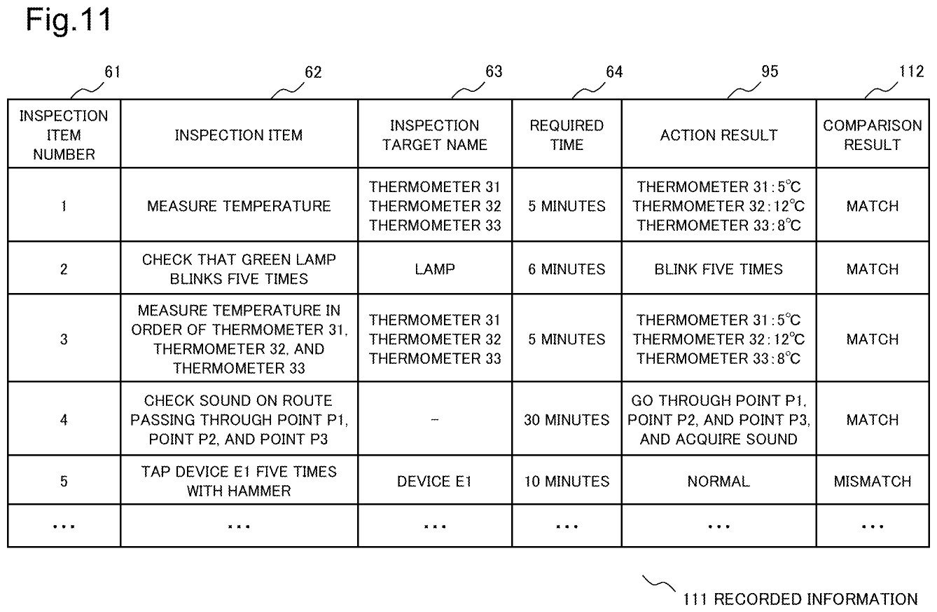

FIG. 11 is a diagram illustrating an example of recorded information 111 recorded in the recording unit 140. The recorded information 111 is acquired by associating a comparison result 112 with each record in the recorded information 90 illustrated in FIG. 9. A comparison result 112 column includes “MATCH” indicating a match or “MISMATCH” indicating a mismatch. The recorded information 111 may further include information about an inspection result based on second data.

The inspection information 60 may further include information indicating whether or not a condition for each inspection target is satisfied. In this case, an action result 95 being information about an inspection result may be information indicating whether or not a condition is satisfied. Thus, information about an action being recognized from data and being included in the recorded information has only to be information based on an action related to inspection.

As described above, the inspection assistance device 101 according to the present example embodiment records a comparison result between information about an inspection result acquired by an action recognized from first data with, for example, information about an inspection result based on second data input by the worker 2, and information about the inspection in association with each other. Consequently, for example, when checking information recorded in the recording unit 140 after performing inspection work, the worker 2 can readily check whether or not there is a mistake in an inspection result.

Further, the display control unit 150 may cause the display unit 160 to display a comparison result. Consequently, the worker 2 can readily grasp whether or not information recognized from first data matches information input by the worker 2 himself/herself.

### Hardware Configuration

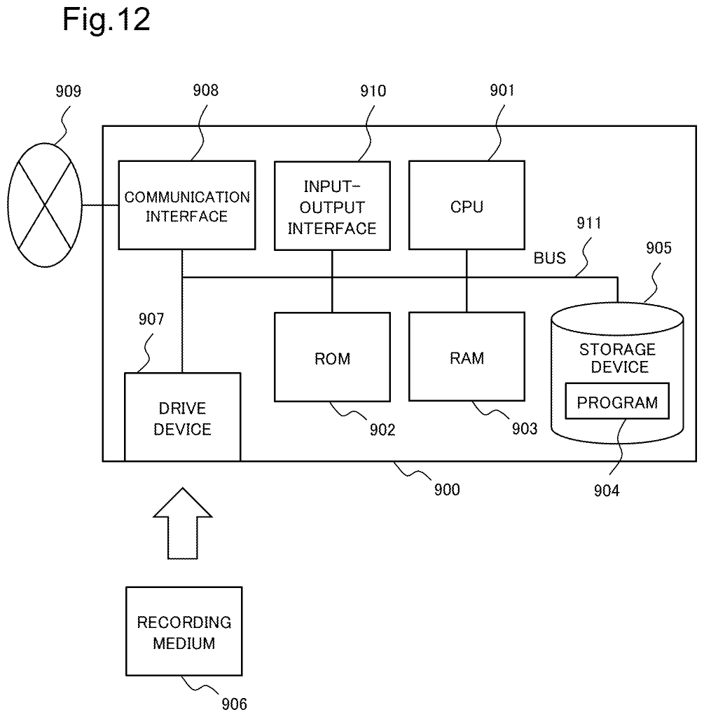

Each component in the inspection assistance device (10, 100, 101) according to each example embodiment of the present disclosure represents a function-based block. For example, a part or the whole of each component in the inspection assistance device (10, 100, 101) is provided by an arbitrary combination of an information processing device 900 and a program, as illustrated in FIG. 12. FIG. 12 is a block diagram illustrating an example of a hardware configuration of the information processing device 900 providing each component in the inspection assistance device (10, 100, 101). An example of the information processing device 900 includes the following configuration.
A central processing unit (CPU) 901
A read only memory (ROM) 902
A random access memory (RAM) 903
A program 904 loaded on the RAM 903
A storage device 905 storing the program 904
A drive device 907 for reading and writing of a recording medium 906
A communication interface 908 connected to a communication network 909
An input-output interface 910 inputting and outputting data
A bus 911 connecting each component

Each component in the inspection assistance device (10, 100, 101) according to each example embodiment is provided by the CPU 901 acquiring and executing the program 904 providing the function of the component. For example, the program 904 providing the function of each component in the inspection assistance device (10, 100, 101) is previously stored in the storage device 905 or the ROM 902, and is read by the CPU 901 as needed. The program 904 may be provided for the CPU 901 through the communication network 909, or may be previously stored in the recording medium 906, be read by the drive device 907, and be provided for the CPU 901.

There are various modified examples of a method of providing the inspection assistance device (10, 100, 101). For example, the inspection assistance device (10, 100, 101) may be provided by an arbitrary combination of an information processing device 900 and a program, the combination being separate for each component. Further, a plurality of components included in the inspection assistance device (10, 100, 101) may be provided by an arbitrary combination of a single information processing device 900 and a program.

Further, a part or the whole of each component in the inspection assistance device (10, 100, 101) is provided by another general-purpose or dedicated circuit, a processor, or the like, or a combination thereof. The above may be configured with a single chip or may be configured with a plurality of chips connected through a bus.

A part or the whole of each component in the inspection assistance device (10, 100, 101) may be provided by a combination of the aforementioned circuit or the like, and a program.

When a part or the whole of each component in the inspection assistance device (10, 100, 101) is provided by a plurality of information processing devices, circuits, or the like, the plurality of information processing devices, circuits, or the like may be arranged in a concentrated manner or be arranged in a distributed manner. For example, the respective information processing devices, circuits, or the like may be provided in a form of being connected with each other through a communication network such as a client-server system or a cloud computing system.

The respective aforementioned example embodiments are preferred example embodiments of the present disclosure, and the scope of the present disclosure is not limited to the respective aforementioned example embodiments; and a person skilled in the art may make example embodiments which include various changes through modifying and substituting the respective aforementioned example embodiments without departing from the spirit and scope of the present disclosure.

The aforementioned example embodiments may also be described in part or in whole as the following Supplementary Notes but are not limited thereto.

### Supplementary Note 1

An inspection assistance device including:

a data acquisition means configured to acquire data generated by an action for an inspection;

a time acquisition means configured to acquire a first time required for an action for the inspection, from the data; and

a recording control means configured to, when the first time and a second time predetermined as a time required for an action for the inspection are in a predetermined relation, record information about an action recognized from the data and information about the inspection in association with each other.

### Supplementary Note 2

The inspection assistance device according to Supplementary Note 1, wherein, when the first time and the second time are in a predetermined relation, and a first action recognized from the data and a second action predetermined as an action for the inspection are in a predetermined relation, the recording control means records information about a first action recognized from the data and information about the inspection in association with each other.

### Supplementary Note 3

The inspection assistance device according to Supplementary Note 2, wherein, when an order in which a plurality of actions included in the first action are performed matches an order in which a plurality of actions included in the second action are performed, the recording control means records information about an action recognized from the data and information about the inspection in association with each other.

### Supplementary Note 4

The inspection assistance device according to any one of Supplementary Notes 1 to 3, wherein

data acquired by the data acquisition means are image data captured by an imaging device, and

the time acquisition means acquires the first time, based on whether or not a predetermined action is included in the image data.

### Supplementary Note 5

The inspection assistance device according to any one of Supplementary Notes 1 to 3, wherein

data acquired by the data acquisition means are image data captured by an imaging device capturing a direction of a line of sight of a worker, and

the time acquisition means acquires the first time, based on an amount of movement of a line of sight of the worker, the amount being calculated from the image data.

### Supplementary Note 6

The inspection assistance device according to any one of Supplementary Notes 1 to 3, wherein

data acquired by the data acquisition means are image data captured by an imaging device, and

the time acquisition means acquires the first time, based on whether or not a target related to an action for the inspection is included in the image data.

### Supplementary Note 7

The inspection assistance device according to any one of Supplementary Notes 1 to 3, wherein

data acquired by the data acquisition means are acoustic data collected by a sound collecting device, and

the time acquisition means acquires the first time, based on whether or not a predetermined sound is included in the acoustic data.

### Supplementary Note 8

The inspection assistance device according to any one of Supplementary Notes 1 to 7, wherein

an action for the inspection is an action for acquiring an inspection result on an inspection target, and

the recording control means records information about the inspection result acquired by an action recognized from the data and information about the inspection target in association with each other.

### Supplementary Note 9

The inspection assistance device according to Supplementary Note 8, further including

an inspection result data acquisition means configured to acquire second data being used for acquiring an inspection result on the inspection target and being a different type of data from first data generated by an action for the inspection, wherein

the recording control means records a comparison result between information about the inspection result acquired by an action recognized from the first data and information about an inspection result based on the acquired second data, and information about the inspection in association with each other.

### Supplementary Note 10

The inspection assistance device according to any one of Supplementary Notes 1 to 9, further including

a display control means configured to cause a display unit to display recording result information based on a result of recording by the recording control means.

### Supplementary Note 11

An inspection assistance method including:

acquiring data generated by an action for an inspection;

acquiring a first time required for an action for the inspection, from the data; and,

when the first time and a second time predetermined as a time required for an action for the inspection are in a predetermined relation, recording information about an action recognized from the data and information about the inspection in association with each other.

### Supplementary Note 12

The inspection assistance method according to Supplementary Note 11, further including,

when the first time and the second time are in a predetermined relation, and a first action recognized from the data and a second action predetermined as an action for the inspection are in a predetermined relation, recording information about an action recognized from the data and information about the inspection in association with each other.

### Supplementary Note 13

A computer-readable non-transitory recording medium having a program recorded thereon, the program causing a computer to execute:

processing of acquiring data generated by an action for an inspection;

processing of acquiring a first time required for an action for the inspection, from the data;

processing of, when the first time and a second time predetermined as a time required for an action for the inspection are in a predetermined relation, recording information about an action recognized from the data and information about the inspection in association with each other; and

processing.

### Supplementary Note 14

The recording medium according to Supplementary Note 13, wherein,

when the first time and the second time are in a predetermined relation, and a first action recognized from the data and a second action predetermined as an action for the inspection are in a predetermined relation, the processing of recording records information about an action recognized from the data and information about the inspection in association with each other.

### REFERENCE SIGNS LIST

1 Wearable glasses
2 Worker
3 Inspection target
4 Inspection assistance system
5 Wearable glasses
6 Server device
7 Inspection assistance system
10 Inspection assistance device
11 Data acquisition unit
12 Time acquisition unit
13 Recording control unit
31 Thermometer
32 Thermometer
33 Thermometer
60 Inspection information
61 Inspection item number
62 Inspection item
63 Inspection target name
64 Required time
90 Recorded information
111 Action result
111 Recorded information
112 Comparison result
100 Inspection assistance device
101 Inspection assistance device
110 Data acquisition unit
120 Time acquisition unit
130 Recording control unit
140 Recording unit
150 Display control unit
160 Display unit
170 Inspection result data acquisition unit
200 Data acquisition device
300 Input device

1. An inspection assistance device comprising:
at least one memory storing instructions; and
at least one processor connected to the at least one memory and configured to execute the instructions to:
acquire data generated by an action for an inspection;
acquire a first time required for an action for the inspection, from the data; and
when the first time and a second time predetermined as a time required for an action for the inspection are in a predetermined relation, record information about an action recognized from the data and information about the inspection in association with each other.

2. The inspection assistance device according to claim 1, wherein the at least one processor is configured to execute the instruction,
when the first time and the second time are in a predetermined relation, and a first action recognized from the data and a second action predetermined as an action for the inspection are in a predetermined relation, to record information about a first action recognized from the data and information about the inspection in association with each other.

3. The inspection assistance device according to claim 2, wherein the at least one processor is configured to execute the instruction,
when an order in which a plurality of actions included in the first action are performed matches an order in which a plurality of actions included in the second action are performed, to record information about an action recognized from the data and information about the inspection in association with each other.

4. The inspection assistance device according to claim 1, wherein the at least one processor is configured to execute the instructions to:
acquire image data captured by an imaging device as the data; and
acquire the first time, based on whether a predetermined action is included in the image data.

5. The inspection assistance device according to claim 1, wherein the at least one processor is configured to execute the instructions to:
acquire image data captured by an imaging device capturing a direction of a line of sight of a worker as the data; and
acquire the first time, based on an amount of movement of a line of sight of the worker, the amount being calculated from the image data.

6. The inspection assistance device according to claim 1, wherein the at least one processor is configured to execute the instructions to:
acquire image data captured by an imaging device as the data; and
acquire the first time, based on whether a target related to an action for the inspection is included in the image data.

7. The inspection assistance device according to claim 1, wherein the at least one processor is configured to execute the instructions to:
acquire acoustic data collected by a sound collecting device as the data; and
acquire the first time, based on whether a predetermined sound is included in the acoustic data.

8. The inspection assistance device according to claim 1, wherein the at least one processor is configured to execute the instructions to:
acquire an action for acquiring an inspection result on an inspection target as an action for the inspection; and
record information about the inspection result acquired by an action recognized from the data and information about the inspection target in association with each other.

9. The inspection assistance device according to claim 8, wherein the at least one processor is configured to execute the instructions to:
acquire second data being used for acquiring an inspection result on the inspection target and being a different type of data from first data generated by an action for the inspection, and
record a comparison result between information about the inspection result acquired by an action recognized from the first data and information about an inspection result based on the acquired second data, and information about the inspection in association with each other.

10. The inspection assistance device according to claim 1, wherein the at least one processor is configured to execute the instruction
to cause a display to display recording result information based on a result of recording of the recorded information.

11. An inspection assistance method comprising:
acquiring data generated by an action for an inspection;
acquiring a first time required for an action for the inspection, from the data; and,
when the first time and a second time predetermined as a time required for an action for the inspection are in a predetermined relation, recording information about an action recognized from the data and information about the inspection in association with each other.

12. The inspection assistance method according to claim 11, further comprising,
when the first time and the second time are in a predetermined relation, and a first action recognized from the data and a second action predetermined as an action for the inspection are in a predetermined relation, recording information about an action recognized from the data and information about the inspection in association with each other.

13. A computer-readable non-transitory recording medium having a program recorded thereon, the program causing a computer to execute:
processing of acquiring data generated by an action for an inspection;
processing of acquiring a first time required for an action for the inspection, from the data; and
processing of, when the first time and a second time predetermined as a time required for an action for the inspection are in a predetermined relation, recording information about an action recognized from the data and information about the inspection in association with each other.

14. The recording medium according to claim 13, wherein,
when the first time and the second time are in a predetermined relation, and a first action recognized from the data and a second action predetermined as an action for the inspection are in a predetermined relation, the processing of recording records information about an action recognized from the data and information about the inspection in association with each other.
